(19) United States
(12) Patent Application Publication
(10) Pub. No.: US 2025/0055566 A1
(43) Pub. Date: Feb. 13, 2025

(54) WINDOW MOUNTED WIRELESS GATEWAY SYSTEM

(71) Applicant: T.Mobile USA, Inc., Bellevue, WA (US)

(72) Inventors: Chad Au, Kirkland, WA (US); Jun Liu, Lssaquah, WA (US)

(21) Appl. No.: 18/232,486

(22) Filed: Aug. 10, 2023

(51) Int. Cl. H04B 10/114

(52) U.S. Cl. CPC H04B 10/114

(57) ABSTRACT

A window mounted wireless gateway system having an indoor unit to communicate with user equipment within a physical structure and an outdoor unit configured to communicate with a network. The indoor unit and outdoor unit may, respectively, be applied to the interior and exterior panes of a window of the structure. The indoor and outdoor units may be in optical communication with each other via optical signals transmitted through the window.

### BACKGROUND

Today many mobile network operators provide high speed wireless internet services to their customers. One concern with mobile network internet services is that customers may experience a degradation of service when in an indoor environment. For instance, structures and walls of a building or home may often attenuate radio signals as the radio signals propagate or pass through. In some cases, customers may deploy outdoor radio frequency repeaters to amplify the radio signals to compensate for the expected attenuation. However, the radio frequency repeaters often retransmit entire frequency bands and can cause interference with a desired spectrum associated with wireless internet services, thereby reducing reception in outdoor environments. In this manner, the customer often has to choose between poor indoor service or poor outdoor services with respect to their properties. In another instance, the repeater may be placed indoors. However, the indoor signal's quality will have then be degraded, with the repeater amplifying a poor-quality signal having low throughput. It is also possible the indoor signal will be degraded to the point where it is incoherent, resulting in the repeater amplifying noise.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of an architecture for a window mounted wireless gateway system according to some implementations.

FIG. 2 is another example block diagram of an architecture for a window mounted wireless gateway system according to some implementations.

FIG. 3 is another example block diagram of an architecture for a window mounted wireless gateway system according to some implementations.

FIG. 4 is a flow diagram illustrating an example process associated with receiving data from a network according to some implementations.

FIG. 5 is a flow diagram illustrating an example process associated with sending data to a network according to some implementations.

FIG. 6 is a flow diagram illustrating an example process associated configuring or installing the window mounted wireless gateway system according to some implementations.

### DETAILED DESCRIPTION

Discussed herein is a window mounted wireless (wireless standard) gateway system for mitigating radio frequency (RF) signal degradation or attenuation experienced in an indoor environment without introducing interference that may attenuate or degrade outdoor RF signals. In some cases, a mobile network may provide a wireless internet service via RF signals over a licensed or desired RF spectrum. For example, in some situations, building materials and structures, such as walls, may attenuate the RF signals. The attenuation may cause a degradation of mobile wireless service provided by a mobile network using RF technologies, particularly in the indoor environments.

The window mounted Wi-Fi gateway system, discussed herein, may include two paired units. The first unit may be configured for outdoor use, such as on the exterior of a window, and the second unit may be configured for indoor use, such as on the interior of the window. The outdoor unit may be aligned with the indoor unit, such that the units may communicate with each other via an optical transmission through the windowpane. As an illustrative example, the outdoor unit may include one or more antennas and a wireless modem for receiving and decoding the RF signals (e.g., the network wireless transmission broadcast, for instance, from one or more network towers, small cells, or other wireless network infrastructure). The system may convert the decoded RF signals into an optical-based signal that may be transmitted by a transmitter or a through the glass to an aligned or paired receiver in the indoor unit. The indoor unit may then convert the optical-based signal into a wired and/or wireless indoor signal which may be distributed throughout the indoor environment, via a router, to a user equipment (UE). The indoor unit may receive a wireless signal (such as a response signal) from the UE at the router within the indoor environment. The indoor unit may then covert the wireless signal to an optical-based signal and transmit through the windowpane back to a receiver in the outdoor unit. The outdoor unit may covert to an RF signal and transmit or send the user's data packet to a destination over the network.

In this manner, unlike conventional RF repeaters that amplify the RF signals that may interfere with the spectrum associated with wireless internet services and may reduce reception in outdoor environments, the window mounted Wi-Fi gateway system provides for indoor home network or modem services without interfering with outdoor performance of the mobile network.

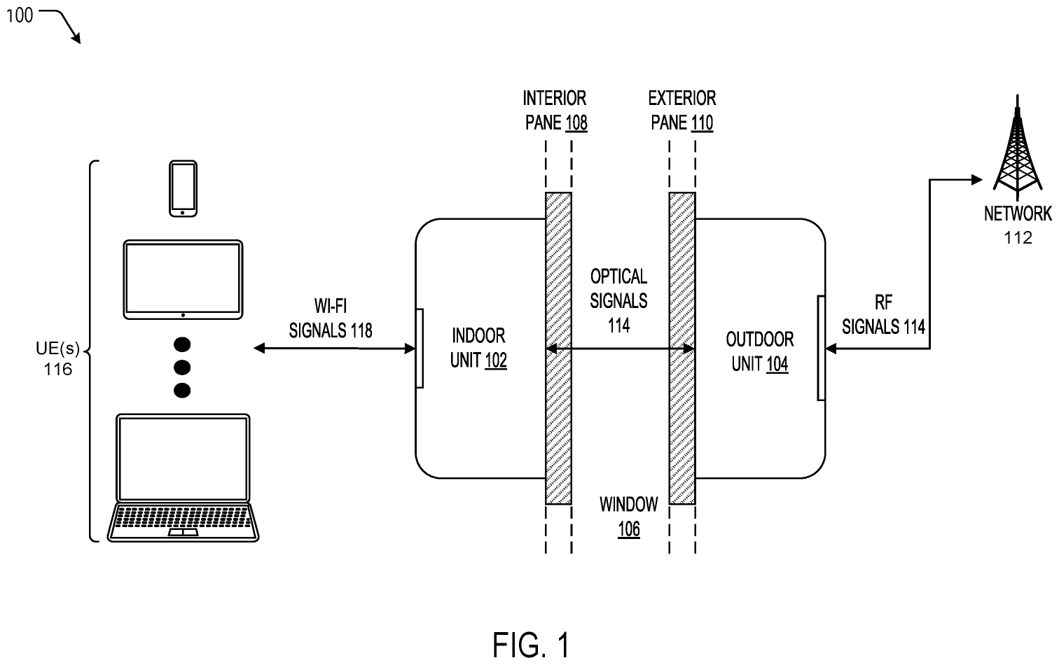

FIG. 1 is an example block diagram of an architecture for a window mounted wireless (Wi-Fi) gateway system 100 according to some implementations. In the current example, the window mounted Wi-Fi gateway system 100 includes an indoor unit 102 and an outdoor unit 104. The indoor unit 102 and the outdoor unit 104 may be aligned on opposing sides (e.g., the interior and exterior, respectively) of window 106 having one or more panes of glass, such as an interior pane 108 and an exterior pane 110 illustrated in the current example. The alignment may be configured such that one or more transmitters operating in multiple frequency bands of the indoor unit 102 align with one or more receivers of the exterior unit 104 and one or more receivers of the indoor unit 102 align with one or more transmitters of the exterior unit 104. For instance, an optical receiver of the indoor unit 102 may align with an optical transmitter of the outdoor unit 104 and an optical receiver of the outdoor unit 104 may align with an optical transmitter of the indoor unit 102.

In the current example, the outdoor unit 104 may be in wireless communication with a network 112, such as a mobile network providing high speed wireless internet services to an end-user. In this manner, the outdoor unit 104 may be configured to receive incoming data via RF signals 114 received from the network 112 and to transmit outgoing data via RF signals 114 sent to the network 112. Likewise, the indoor unit 102 may be in wireless communication with one or more UEs 116, such as smart phones, televisions, smart appliances, tablets, personal computers, and the like associated with the end-user. In this manner, the indoor unit 102 may be configured to receive outgoing data via wireless signals 118 received from the UEs 116 and to transmit incoming data via wireless signals 118 sent to the UEs 116.

In some cases, the alignment between the indoor unit 102 and the outdoor unit 104 may be configured to accommodate one or more coatings applied to the window 106 (e.g., a low-energy coating, tint, argon gas layer, or the like). In this manner, the system 100 may be configured to provide an installation or set-up assistant, such as via a paired downloadable application on a UE 116. For instance, as one illustrative example, a user may apply or adhere the exterior unit 104 to an exterior of a window 106 of their home environment. The user may also download an application to the UE 116. The user may also pair the application hosted on the UE 116 to the interior unit 102 (such as over a home network, Bluetooth, or the like).

The application may then present an alignment graphic or interface on a display of the UE 116 that may assist with aligning the indoor unit 102 with the exterior unit 104. For example, the interface may include a cursor or pointer that represents the interior unit 102 that may move on the interface as the user moves the indoor unit 102. The interface may also present a target that represents the exterior unit 104. In this manner, the user may move the cursor to the target by moving the indoor unit 102 with respect to the window 106 and the outdoor unit 104. The interface may, upon proper alignment (e.g., signal received and/or sent between the indoor unit 102 with the exterior unit 104 greater than one or more thresholds), display an aligned indicator (such as a green indicator) to inform the user to adhere the indoor unit 102 to the window 106 at the current alignment. In this manner, the system 100 may accommodate alignment that may be more complicated than aligning the exteriors of the two units 102 and 104, such as caused by any optical transmission interference that occurs due to coatings, gasses, tinting and the like.

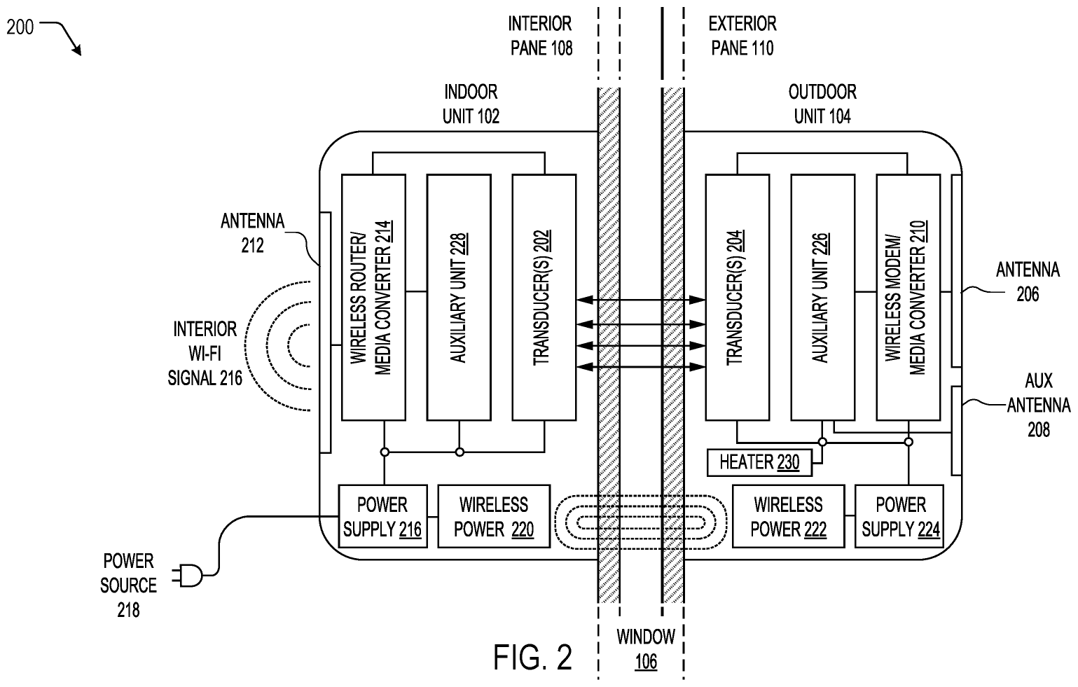

FIG. 2 is an example block diagram of an architecture for a window mounted Wi-Fi gateway system 200 according to some implementations. In the current example, the window mounted Wi-Fi gateway system 200 includes the indoor unit 102 and the outdoor unit 104. The indoor unit 102 and the outdoor unit 104 may be aligned (as discussed above with respect to FIG. 1) on opposing sides (e.g., the interior and exterior, respectively) of the window 106 having one or more panes of glass (such as the interior pane 108 and the exterior pane 110 illustrated in the current example). The alignment may be configured such that one or more transducers or optical coupler 202 of the indoor unit 102 align with one or more transducers or optical coupler 204 of the exterior unit 104. For instance, an optical receiver of the indoor unit 102 may align with an optical transmitter of the outdoor unit 104 and an optical receiver of the outdoor unit 104 may align with an optical transmitter of the indoor unit 102.

The outdoor unit 104 may include one or more antenna 206 position with respect to an antenna aperture as well as one or more axillary antenna 208 positioned with respect to an axillary aperture. The antennas 206 and axillary antennas 208 may be coupled to a wireless modem/media converter 210. The wireless modem 210 may be configured to decode the RF signals received by the antennas 206 and/or 208 from one or more networks, such as network 112 of FIG. 1. The wireless modem 210 may be in electronic communication with the transducers 204. The transducers 204 may be in communications with the transducers 202 of the indoor unit 102 via optical-based signals, as discussed herein.

The indoor unit 102 may include one or more antenna 212 position with respect to an antenna aperture. The antennas 212 may be coupled to a wireless router/media converter 214. The wireless router 214 of the indoor unit 102 may be configured to decode the interior Wi-Fi signals 216 received by the antennas 212 from, for instance, a UE within the interior environment, such as UEs 116 of FIG. 1. The wireless router 214 may be in electronic communication with the transducers 202. The transducers 202 may be in communications with the transducers 204 of the indoor unit 102 via the optical-based signals.

The indoor unit 102 may also include a power supply 216 that may be coupled to a power source 218 (such as an outlet in the interior environment). The power supply 216 may provide power to the indoor unit 102 and act as a power source for the outdoor unit 104. For instance, the power supply 216 may be coupled to a wireless power transmitter 220 to output a power signal such as an inductive power supply signal. The outdoor unit 104 may be equipped with a wireless power receiver 222 that may be charged by or capture the inductive power supply signal. The wireless power receiver 222 may be coupled to a power supply 224 of the outdoor unit 104.

The outdoor unit 104 may also include an auxiliary unit 226 and the indoor unit may also include an auxiliary unit 228. The auxiliary units 226 and 228 may be configured to decode or encode RF and wireless signals, respectively, for other devices and/or networks, such as an internet of things (IoT) device(s) and/or networks as well as other wireless systems within the indoor environment. For instance, the axillary antennas 208 may be associated with a second wireless internet provider or network and the auxiliary units 226 may be used to decode, encode, and/or otherwise process the RF signals of the second wireless internet provider or other network. Likewise, the auxiliary units 228 may be associated with controlling smart devices, such as thermostats, appliances, and the like via the Wi-Fi signals 216.

The outdoor unit 104 may also include a heater 230 for maintaining a temperature of the outdoor unit 104 within a desired range or above a threshold. For instance, in some cases, the outdoor unit 104 may be installed in climates that experience extreme cold or freezing temperatures. In these environments, the heater 230 may be configured to maintain a temperature of the outdoor unit 104, such that the outdoor unit 104, may continue to operate normally in freezing and/or sub-freezing temperature. In some cases, the heater 230 may also be configured to prevent the window 106 from frosting and, thereby, interrupting mobile internet services.

In some examples, to provide for improved security and serviceability of the outdoor unit 104, the unit 104 may be applied or coupled to the exterior pane 110 of the window 106 via a heat deactivated adhesive. In this manner, the outdoor unit 104 may be difficult to remove without access to an application in wireless communication with the indoor unit 102 and associated with the window mounted gateway 200. For example, by use of the heat deactivated adhesive, the outdoor unit 104 may be difficult to remove from the window 106 by the application of force by, for instance, a thief, as the thief may not be able to utilize the heater 230 to apply heat and cause the adhesive to deactivate. Likewise, the removal of the outdoor unit 104 (and/or an indoor unit 102 also utilizing heat deactivated adhesive) may be more serviceability, by a technician or an owner, as the technician may utilize controls on a paired or wirelessly coupled user device to cause the heater 230 to apply heat to the adhesive, thereby deactivating the adhesive and allowing for easy removal without risk of damaging the window 106 or the panes 108 or 110.

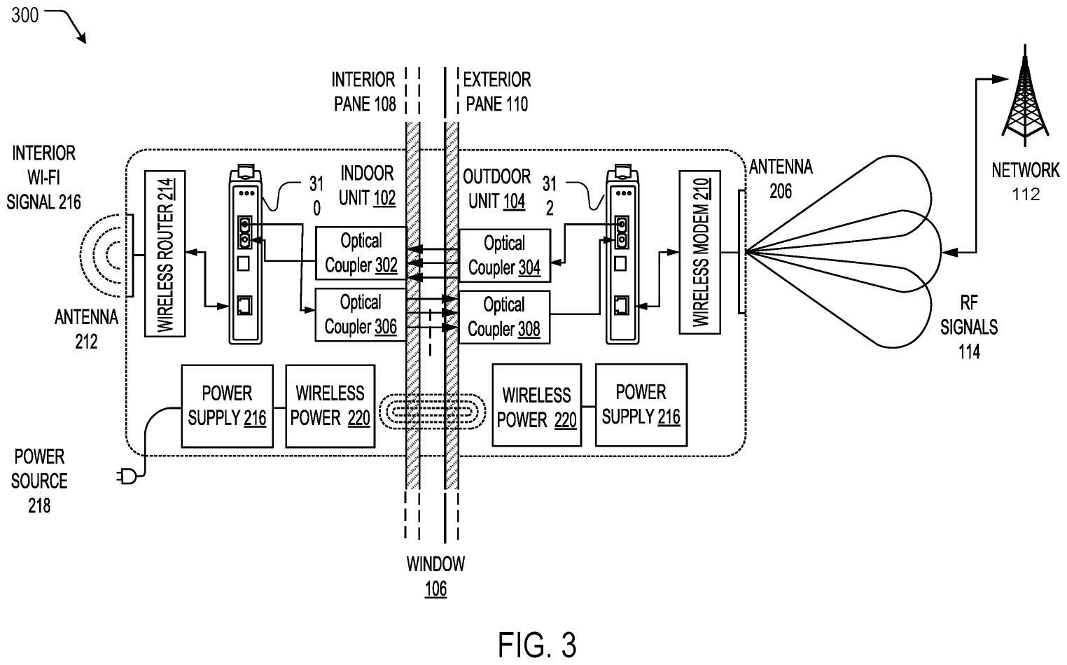

FIG. 3 is another example block diagram of an architecture for a window mounted wireless (Wi-Fi) gateway system 300 according to some implementations. In the current example, the window mounted Wi-Fi gateway system 300, again, includes the indoor unit 102 and the outdoor unit 104. As discussed above, the indoor unit 102 and the outdoor unit 104 may be aligned (as discussed above with respect to FIG. 1) on opposing sides (e.g., the interior and exterior, respectively) of the window 106 having one or more panes of glass (such as the interior pane 108 and the exterior pane 110 illustrated in the current example).

The alignment may be configured such that a first optical coupler 302 (or transducer, collimator, or the like) of the indoor unit 102 aligns with a first optical coupler 304 (or transducer, collimator, or the like) of the exterior unit 104, such that data may be transmitted from the first optical coupler 304 of the exterior unit 104 to the first optical coupler 302 of the indoor unit 102. Likewise, a second optical coupler 306 of the indoor unit 102 aligns with a second optical coupler 308 of the exterior unit 104, such that data may be transmitted from the second optical coupler 306 of the indoor unit 102 to the second optical coupler 308 of the exterior unit 104. For instance, the optical couplers 304 and 306 may output the data as an optical-based signal that may be received by the optical couplers 302 and 308, respectively.

The outdoor unit 104 may also include one or more antenna 206 positioned with respect to an antenna aperture. The antennas 206 may be coupled to a wireless modem/media converter 210. The wireless modem 210 may be configured to decode the RF signals received by the antennas 206 and/or 208 from one or more networks, such as network 112 of FIG. 1. The wireless modem 210 may be in electronic communication with the optical couplers 304 and 308. In the current example, the antenna 206 may be a beam forming antenna that may direct the coverage of the system 300 in a desired direction or configuration with respect to the network 112.

In the current example, the antennas 206 may be configured to provide beam forming to improve signal reception and/or transmission with respect to omnidirectional antenna responses and the RF signals 114. In some cases, the antennas 206 may include multiple antennas that are configured to have adjustable phase and amplitude to generate beam or focused area of coverage. In the focused area of coverage, the antennas 206 may provide increased signal strength and/or range, improved signal quality, and otherwise enhanced network capabilities. In these examples, the antennas 206 may be adjusted to have a beam shaped in the direction of a nearest proximate cellular tower or the like.

The indoor unit 102 may include one or more antenna 212 position with respect to an antenna aperture. The antennas 212 may be coupled to a wireless router 214. The wireless router 214 of the indoor unit 102 may be configured to decode the interior Wi-Fi signals 216 received by the antennas 212 from, for instance, a UE within the interior environment. The wireless router 214 may be in electronic communication with the optical couplers 302 and 306.

In the current example, the indoor unit 102 may include a converter 310 (such as a media converter or the like) to decode and/or translate Wi-Fi signals 216 (such as representative of media files) and/or signals (such as representative of media files) received from the optical coupler 302 prior to delivering to the wireless router 214. Likewise, the outdoor unit 104 may include a converter 3102 (such as a media converter or the like) to decode and/or translate RF signals 114 (such as representative of media files) and/or signals (such as representative of media files) received from the optical coupler 308.

As discussed with respect to FIG. 2 above, the indoor unit 102 may also include a power supply 216 that may be coupled to a power source 218 (such as an outlet in the interior environment). The power supply 216 may provide power to the indoor unit 102 and act as a power source for the outdoor unit 104. For instance, the power supply 216 may be coupled to a wireless power transmitter 220 to output a power signal such as an inductive power supply signal. The outdoor unit 104 may be equipped with a wireless power receiver 222 that may be charged by or capture the inductive power supply signal. The wireless power receiver 222 may be coupled to a power supply 224 of the outdoor unit 104.

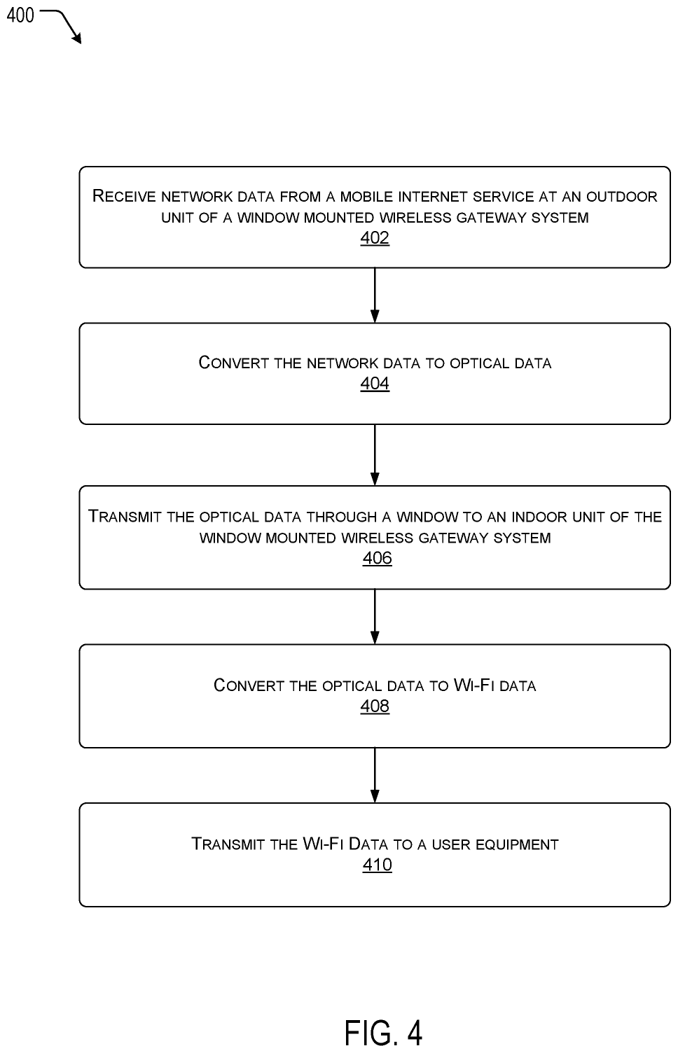

FIGS. 4-6 are flow diagrams illustrating example processes associated with the window mounted Wi-Fi gateway systems discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 4 is a flow diagram illustrating an example process 400 associated with receiving data from a network according to some implementations. In the current example, a window mounted Wi-Fi gateway system may include an indoor unit mounted on an interior of a window and an exterior unit mounted on the exterior of the window. The indoor and outdoor units may be aligned such that the units may send and receive data from each other through the windowpanes. Accordingly, unlike conventional repeaters, the window mounted Wi-Fi gateway system extends the mobile internet coverage indoors without introducing interference in the outdoor environment.

At 402, the window mounted Wi-Fi gateway system may receive network data from a mobile internet service at an outdoor unit. For instance, in the current example, the window mounted Wi-Fi gateway system may receive RF signals containing or encoding data and/or packets transmitted from a network. The network data received may be intended for a UE within a building associated with the window mounted Wi-Fi gateway system that the RF signals may fail to reliably penetrate.

At 404, the outdoor unit of the window mounted Wi-Fi gateway system may convert the network data to optical data. For example, the outdoor unit may include one or more transmitters, such as a optical coupler, that may transmit an optical signal through the window to the indoor unit. In this manner, the system may convert the RF signals received to digital data packets that may be encoded and/or transmitted as optical signals by one or more optical couplers.

At 406, the outdoor unit may transmit the optical data through the window associated with the window mounted Wi-Fi gateway system to the indoor unit. In some cases, the outdoor unit and the indoor unit may be configured and/or aligned in a manner such that any gases, coatings, tints, or the like fail to cause in disruption in the optical data delivery.

At 408, the indoor unit may convert the optical data to Wi-Fi data. for example, the indoor unit may receive the optical data and convert the optical data back to a digital signal.

At 410, the indoor unit may transmit or output the Wi-Fi data to the UE. For example, a router and/or antenna may be configured to output the Wi-Fi data as a wireless signal over a coverage area (such as the interior of the physical environment associated with the window mounted Wi-Fi gateway system). The UE may then receive and decode the Wi-Fi data as configured with respect to internet or wireless communication data.

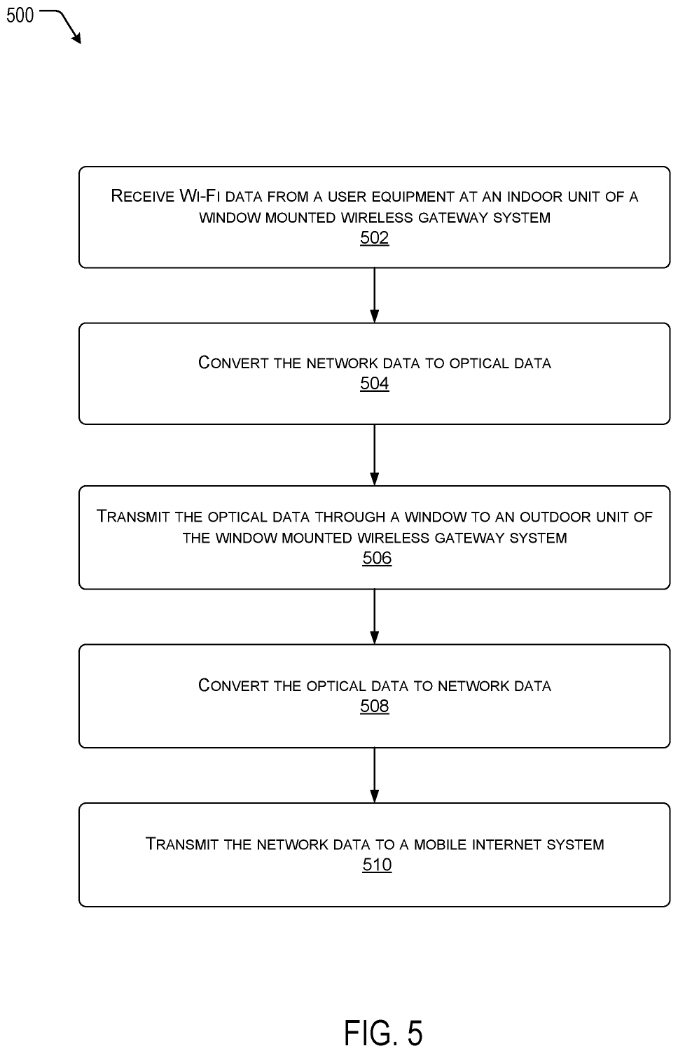

FIG. 5 is a flow diagram illustrating an example process 500 associated with sending data to a network according to some implementations. In the current example, a window mounted Wi-Fi gateway system may include an indoor unit mounted on an interior of a window and an exterior unit mounted on the exterior of the window. The indoor and outdoor units may be aligned such that the units may send and receive data from each other through the windowpanes. Accordingly, unlike conventional repeaters the window mounted Wi-Fi gateway system extends the mobile internet coverage indoors without introducing interference in the outdoor environment.

At 502, the window mounted Wi-Fi gateway system may receive Wi-Fi data from a UE at an outdoor unit. For instance, in the current example, the window mounted Wi-Fi gateway system may receive wireless signals containing or encoding data and/or packets transmitted from the UE to be delivered to the network or a third-party system via the network.

At 504, the indoor unit of the window mounted Wi-Fi gateway system may convert the Wi-Fi data to optical data. For example, the indoor unit may include one or more transmitters, such as a optical coupler, that may transmit an optical signal through the window to the indoor unit. In this manner, the system may convert the Wi-Fi signals received to digital data packets that may be encoded and/or transmitted as optical signals by one or more optical couplers.

At 506, the indoor unit may transmit the optical data through the window associated with the window mounted Wi-Fi gateway system to the outdoor unit. In some cases, the outdoor unit and the indoor unit may be configured and/or aligned in a manner such that any gases, coatings, tints, or the like fail to cause in disruption in the optical data delivery.

At 508, the indoor unit may convert the optical data to network data. For example, the outdoor unit may receive the optical data and convert the optical data back to a digital signal.

At 510, the outdoor unit may transmit or output the network data to the network. For example, a modem and/or antenna may be configured to output the network data as a RF signals to the network.

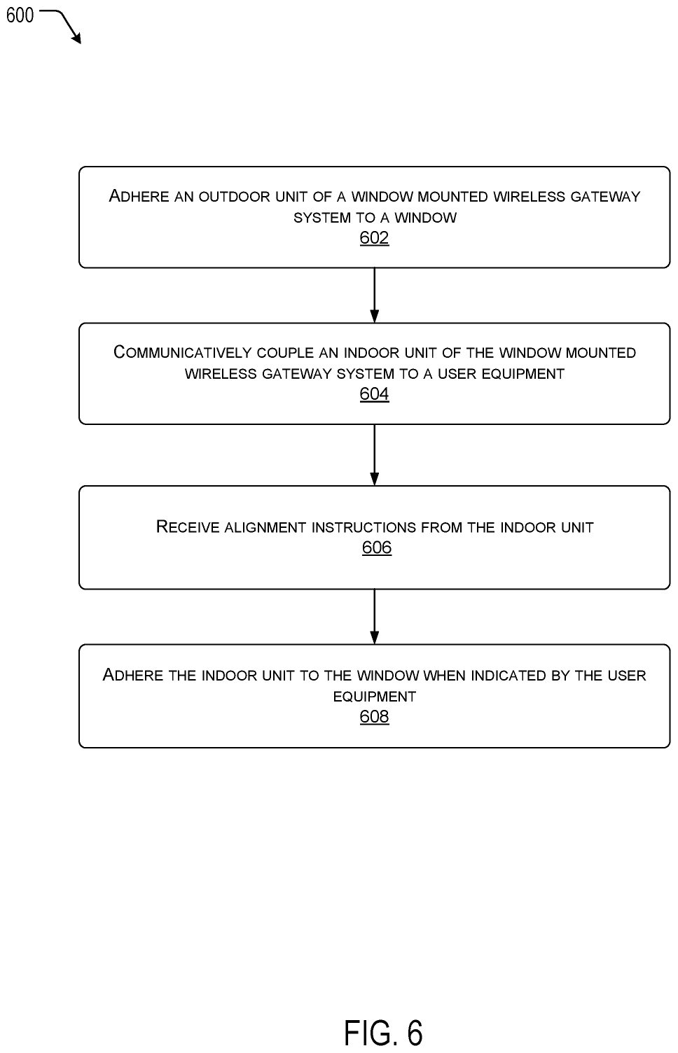

FIG. 6 is a flow diagram illustrating an example process 600 associated configuring or installing the window mounted wireless gateway system according to some implementations. For example, the indoor and outdoor units of the window mounted wireless gateway may be aligned prior to use such that the optical signal transmitted from one unit to the other may be received with a threshold level of reliability and the wireless power signal may be adequately enabled to charge and power the outdoor unit during use.

At 602, a user may adhere or otherwise attach the outdoor unit of the window mounted wireless gateway system to a window of a building, such as their home or office. In some cases, the user may remove a protective layer from the back of the outdoor unit which may expose a layer of adhesive which may be used to couple the outdoor unit to the window.

At 604, the user may communicatively couple an indoor unit of the window mounted wireless gateway system to a UE. For example, the system may be powered and activated to provide a local area network to which the UE may connect.

At 606, the UE may receive alignment instructions from the indoor unit as the indoor unit is moved with respect to the outdoor unit. In some cases, the indoor and outdoor unit may attempt to send data via the optical transmitters and receivers until the signal quality is above a desired threshold for each pair of transmitters and receivers. The indoor unit may provide feedback via the UE to the user as the signal quality improves or degrades as the indoor unit is moved. In this manner, the UE may assist with guiding the user to properly align the indoor unit with respect to the outdoor unit.

At 608, the user may adhere the indoor unit to the window when indicated by the UE. For example, when the indoor unit is properly aligned with the outdoor unit, the indoor unit may cause the UE to display an indication to the user that the indoor unit is properly aligned and should be coupled to the window at the current location/position.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

What is claimed is:

1. A system comprising:
an outdoor unit configured to couple to an exterior surface of a window, the indoor unit comprising:
a first antenna for receiving a first wireless signal from a network;
a first wireless modem in electronic communication with the first antenna, the first wireless modem configured to decode the first wireless signal; and
a first transducer in electronic communication with the first wireless modem, the first transducer to transmit the first wireless signal as a first optical signal;
an indoor unit configured to couple to an interior surface of the window, the indoor unit comprising:
a second transducer physically aligned with the first transducer to receive the first optical signal from the first transducer through the window;
a second wireless modem in electronic communication with the second transducer; and
a second wireless antenna to transmit the first optical signal as a second wireless signal to a user equipment.

11. The system of claim 1, wherein:
the second antenna is configured to receive a third wireless signal from the user equipment; and
the indoor unit further comprises a third transducer to transmit the third wireless signal as a second optical signal;
the indoor unit further comprises a fourth transducer physically aligned with the third transducer to receive the second optical signal from the third transducer through the window; and
the first antenna is configured to output the second optical signal as a fourth wireless signal to the network.

3. The system of claim 1, wherein the indoor unit further comprises:
a power supply electronically coupled to a power source; and
a wireless power transmitter to output a wireless charging signal.

4. The system of claim 3, wherein the outdoor unit further comprises:
a wireless power receiver to capture power from the wireless charging signal; and
a power supply coupled to the wireless power receiver to store the power.

5. The system of claim 1, wherein the outdoor unit further comprises a heater.

6. The system of claim 1, wherein the outdoor unit further comprises a third antenna for sending and receiving additional wireless signals from a second network.

7. The system of claim 1, wherein the indoor unit further comprises an auxiliary unit for encoding and decoding communication signals with an internet of things device in wireless communication with the indoor unit.

8. The system of claim 1, wherein the first transducer is a first optical coupler and the second transducer is a second optical coupler.

9. An outdoor unit of a window mounted wireless gateway system comprising:
a first antenna for sending and receiving radio frequency signals associated with a first network;
a wireless modem in electronic communication with the first antenna, the wireless modem configured to decode the radio frequency signals; and
a first transducer in electronic communication with the wireless modem and optical communication with an indoor unit of the window mounted wireless gateway system.

10. The outdoor unit of claim 9, further comprising a wireless power receiver to capture power from a wireless charging signal.

11. The outdoor unit of claim 10, further comprising a power supply coupled to the wireless power receiver.

12. The outdoor unit of claim 9, wherein the first antenna comprises two or more antennas and wherein the two or more antennas are configured to utilize beamforming with respect to sending and receiving the radio frequency signals associated with the first network.

13. The outdoor unit of claim 9, further comprising an auxiliary antenna for sending and receiving additional radio frequency signals associated with a second network.

14. The outdoor unit of claim 9, further comprising an adhesive for coupling the outdoor unit to an exterior surface of a window.

15. The outdoor unit of claim 9, further comprising a second transducer in electronic communication with the wireless modem and optical communication with the indoor unit of the window mounted wireless gateway system.

16. An indoor unit of a window mounted wireless gateway system comprising:
an antenna for sending and receiving wireless signals associated with a user equipment;
a wireless modem in electronic communication with the antenna, the wireless modem configured to decode the wireless signals; and
a first transducer in electronic communication with the wireless modem and optical communication with an outdoor unit of the window mounted wireless gateway system.

17. The indoor unit of claim 16, further comprising a power supply coupled to a power source and a wireless power transmitter, the wireless power transmitter to generate a wireless charging signal.

18. The indoor unit of claim 16, further comprising an auxiliary unit for encoding and decoding additional wireless signals associated with an internet or things device.

19. The indoor unit of claim 16, further comprising an adhesive for coupling the indoor unit to an interior surface of a window.

20. The outdoor unit of claim 9, further comprising a second transducer in electronic communication with the wireless modem and optical communication with the outdoor unit of the window mounted wireless gateway system.
